(19) United States
(12) Patent Application Publication
(10) Pub. No.: US 2015/0294271 A1
(43) Pub. Date: Oct. 15, 2015

(54) GOTGURU SYSTEM

(71) Applicant: Mark D. Lythgoe, Park City, UT (US)

(72) Inventor: Mark D. Lythgoe, Park City, UT (US)

(21) Appl. No.: 14/249,232

(22) Filed: Apr. 9, 2014

(51) Int. Cl. G06Q 10/10; G09B 7/02

(52) U.S. Cl. CPC G06Q 10/1053; G09B 7/02

(57) ABSTRACT

A method and apparatus can provide online assessment of employment candidates, and includes an online skills test with a test verification system, interview, and reference check. The method and apparatus additionally can include a member system, and can further provide a talent auction system.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to a method and apparatus for providing online assessment of a person's professional skills and knowledge which includes an online skills test with a test verification system, interview, and reference check. The method and apparatus of the present invention also includes a member system and provides a talent auction system.

### BACKGROUND OF THE INVENTION

It is a problem in the art to match prospective employees with prospective employers. The skills should match the employment openings.

It is also a problem in the art to provide a thorough assessment of a person's abilities, including performing a skills check, background check, and a multi-dimensional interview of prospective member candidates, and to provide information about the members to the prospective job applicants.

For online testing, it is important to verify the identity of the individual taking the test, and to ensure integrity of the testing procedure.

However, it is well known in the field of online testing that many opportunities exist for falsification such as obtaining computer assistance, obtaining human assistance, using reference materials, and substituting one individual test-taker for another.

It is a further problem in the art to ensure anonymity of all identifiable information during the process, until permission is granted by an applicant.

### SUMMARY OF THE INVENTION

From the foregoing, it is seen that it is a problem in the art to provide a method and apparatus meeting the above requirements. According to the present invention, a method and apparatus is provided which meets the aforementioned requirements and needs in the prior art. Specifically, the device according to the present invention provides a method and apparatus for providing online assessment of employment candidates which includes an online skills test with a test verification system, interview, and reference check.

The method and apparatus of the present invention also includes a talent auction system.

The method and apparatus of the present invention also includes a member system.

Other objects and advantages of the present invention will be more readily apparent from the following detailed description when read in conjunction with the accompanying drawings.

### BRIEF DESCRIPTION OF THE DRAWINGS

FIG. 1 is a schematic diagram illustrating an apparatus for implementing the method of the present invention.

FIG. 2 is a flow chart schematically illustrating steps performed in verification of a candidate, according to the present invention.

FIG. 3 is a flow chart schematically illustrating steps performed in assembling member data into a database, according to the present invention.

FIG. 4 is a flow chart schematically illustrating interaction needed to remove anonymity, according to the present invention.

FIG. 5 is a schematic diagram illustrating an apparatus for implementing steps for candidate evaluation, ranking, and scoring, according to the present invention.

FIG. 6 is a flow chart schematically illustrating steps performed in conducting a candidate auction process, according to the present invention.

FIG. 7 is a process overview, illustrating steps for performing the method according to the present invention.

### DETAILED DESCRIPTION OF THE INVENTION

A method and apparatus of the present invention provides online assessment of employment candidates, and includes an online skills test with a test verification system, interview, and reference check. The method and apparatus includes a member system and provides a talent auction system. Other features are also provided, as shown in the drawings and as discussed further hereunder.

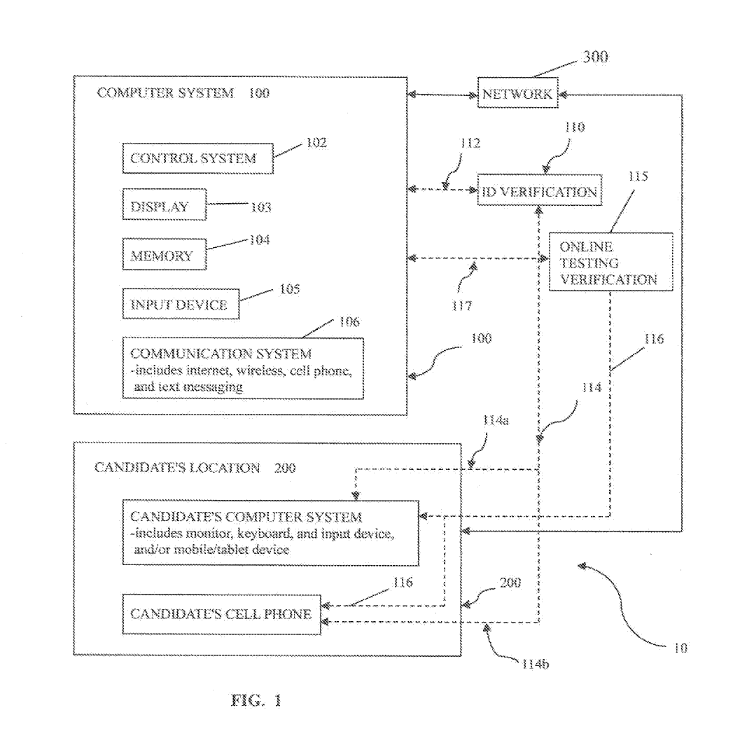

FIG. 1 is a schematic diagram illustrating an apparatus 10 for implementing the method of the present invention. The apparatus 10 includes a computer system 100, a network 300, a candidate's location 200, and an ID verification 110. The ID verification 110 communicates with the computer system 100 as shown by the arrow 112, and with the candidate's location 200 as shown by the arrow 114. The candidate's location 200 includes a candidate's cell phone, and a candidate's computer system having a monitor, keyboard, mobile/tablet device, and/or input device. The mobile/tablet device includes tablet computers, smartphones, and any other electronic devices with similar capabilities.

In FIG. 1, the network communicates with the computer system 100 and with the candidate's location 200 as shown by the (unnumbered) arrows. The computer location includes a control system 11, a display 12, a memory 13, an input device 14, and a communication system 14. The communication system includes internet, wireless, cell phone, smartphone, and/or text messaging. The candidate's computer system communicates with the ID verification 110 as shown by the arrow 114a, and the candidate's cell phone, smartphone, and/or tablet device communicates with the ID verification 110 as shown by the arrow 114b.

The ID verification 110 is a relatively simple system to upload the user's ID and profile picture. This ID verification can includes any means for uploading the user's ID and profile picture, including but not limited to use of a computer, a cell phone, a video monitor, text or data file, among others. Any one having skill in the online identity verification arts would be able to implement the ID verification 110 as described herein.

The present invention further includes an online testing verification 115, which is preferably ongoing and random in nature. It communicates with the candidate's location 200 as indicated by the dashed line 116. The online testing verification 115 communicates with the computer system 100 as indicated by the dashed line 117, such that the computer system 100 can initiate, store, and/or control verification during online testing. In this system of online testing verification 115, the candidate is queried by any or all of: texting, email, instant message, cell phone call, video monitor, and/or other known types of communication. The reply from the candidate's location confirms the candidate is the one identified from the candidate's ID verification.

The online testing verification 115 is described further below and preferably includes an automated system for providing video monitoring, audio monitoring, and/or random interrogation of the candidate via text, email, instant messaging, cell phone calls, among others. Any one having skill in the online identity verification arts would be able to implement the online testing verification 115 as described herein.

The functionality of the online testing verification 115 is that while being tested, the candidate is monitored by video and random interrogation is provided.

The candidate's location 200 can additionally include one or more video cameras, still cameras, audio devices, and other monitoring equipment. Further details of the invention are discussed further hereunder.

An interview (not shown in the drawings) is conducted with multiple interviewers. The interviews are stored in the memory 104 for access later. Further aspects of the interviews and uses thereof, such as grades, are discussed further below.

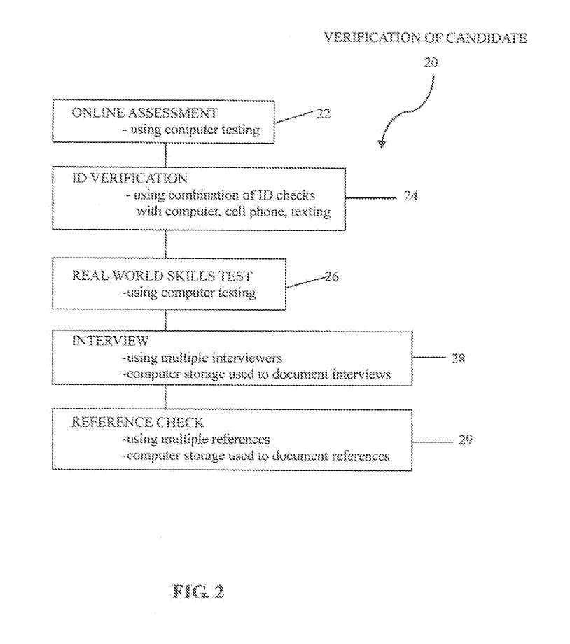

FIG. 2 is a flow chart schematically illustrating verification steps 60 performed in verification of a candidate. The process starts with an online-assessment step 22, using computer testing. This includes an ID verification 24, which preferably includes a combination of ID checks using the computer system 100, cell phone communications, and texting, among others. The process includes a real world skills test step 26 which uses computer testing, and an interview step 28 which preferably includes multiple interviewers and uses a computer storage (stored in the memory 13, for example) to document references (e.g., for storing, organizing, and retrieving reference information). The computer storage can include other storage mediums, and is not limited to the memory 13. The computer storage can include a database, text files, video and audio files, and other types of data as well.

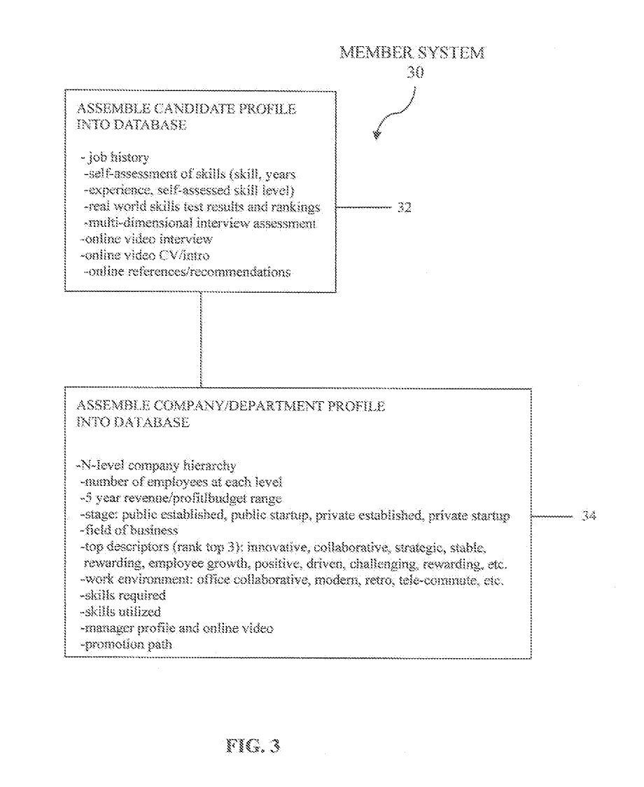

FIG. 3 is a member system schematically illustrating types of data and steps involved in assembling candidate and company/department member data into computer storage, according to the present invention. The computer storage can be in the memory 104, and can include other storage mediums and is not limited to the memory 13. The computer storage can include a database, text files, video and audio files, and other types of data as well.

At step 32, candidate data is assembled into a database or other type of file and stored in the storage medium, to form a candidate profile. This candidate data includes job history, self-assessment of skills (skill, years experience, self-assessed skill level), real world skills test results and rankings, a multi-dimensional interview assessment, an online video interview, an online video CV/intro, and/or online references/recommendations.

At step 34, company/department data is assembled into a database or other type of file and stored in the storage medium, to form a company profile. This company/department data includes N-level company hierarchy, at each level of hierarchy the profile may include: number of employees, 5 year revenue/profit/budget range, the type of stage (public established, public startup, private established, private startup), the field of business, top descriptors (rank top 3: innovative, collaborative, strategic, stable, rewarding, employee growth, positive, driven, challenging, rewarding, etc.), work environment (office collaborative, modern, retro, tele-commute, etc.), skills required, skills utilized, manager profile and online video, and/or promotion path.

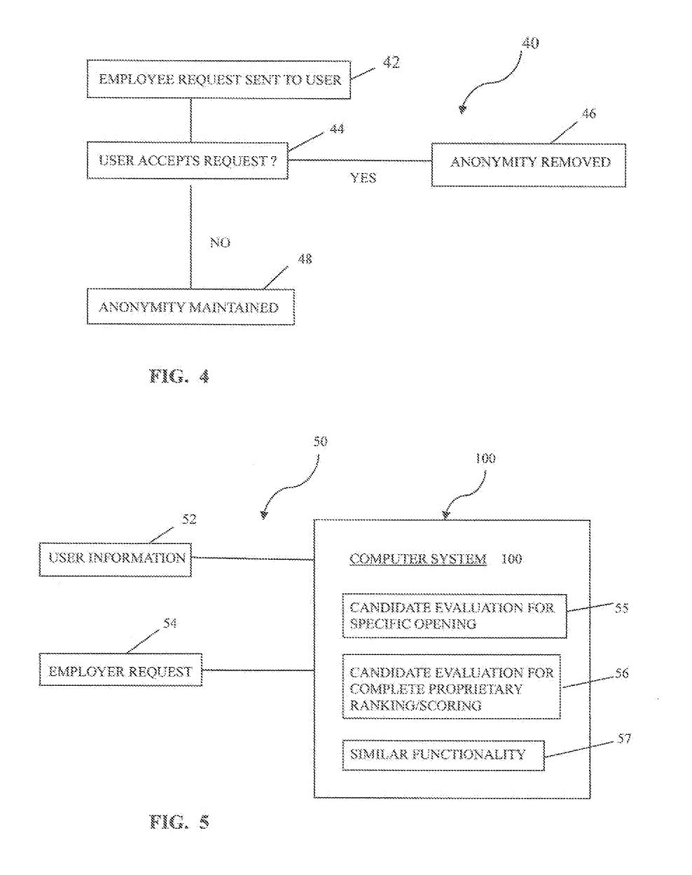

FIG. 4 is a flow chart 40 schematically illustrating interaction needed to remove anonymity, according to the present invention. This includes step 42 wherein an employee request is sent to the user, a step 44 where a decision is made whether to accept the request, a step 46 resulting when the decision at step 44 is YES resulting in anonymity being removed, and a step 48 resulting when the decision at step 44 is NO resulting in anonymity being maintained.

FIG. 5 is a schematic diagram illustrating an apparatus for implementing steps for candidate evaluation, ranking, and scoring, according to the present invention. In this diagram, user data 52 and an employer request can be supplied to a computer system 100. The computer system 100 includes storage as described hereinabove with respect to FIGS. 1-4, including the candidate information and company/department information.

The computer system of FIG. 5 is capable of forming a candidate evaluation 55 for a specific opening, the candidate's evaluation for complete proprietary ranking/scoring 56, and can determine similar functionality 57. This is discussed further hereunder.

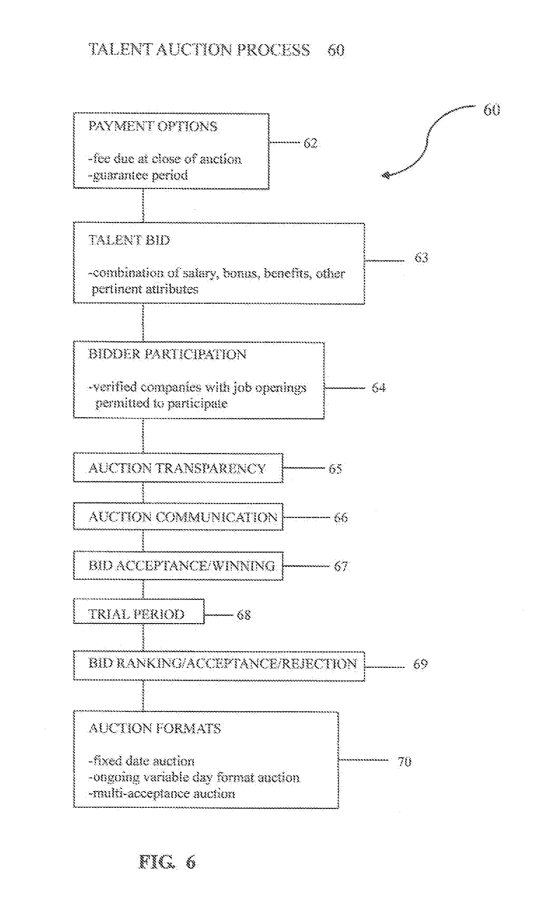

FIG. 6 is a flow chart 60 for a talent auction process, schematically illustrating steps performed in conducting the candidate auction process, according to the present invention. The steps shown are illustrative of a preferred embodiment but are not necessarily performed in this order, and any variations are contemplated as being within the scope of the present invention.

The flow chart 60 is illustrative, and not necessarily sequential. In the flow chart 60, payment options are indicated at step 62, indicating fee due at close of auction and a guarantee period. Step 63 indicates a talent bid, which may include a combination of salary, bonus, benefits, and/or any other pertinent attributes. Bidder participation is shown at step 64, wherein verified companies with job openings are permitted to participate. Step 65 indicates auction transparency, which is known for example in other types of online auction sites. Step 66 indicates auction communication, wherein parties involved are notified during the process. Step 67 indicates bid acceptance/winning Step 68 indicates the trial period. Step 69 indicates bid ranking/acceptance/rejection. Step 70 indicates auction formats, including but not limited to: fixed date auction, ongoing variable day format auction, and multi-acceptance auction.

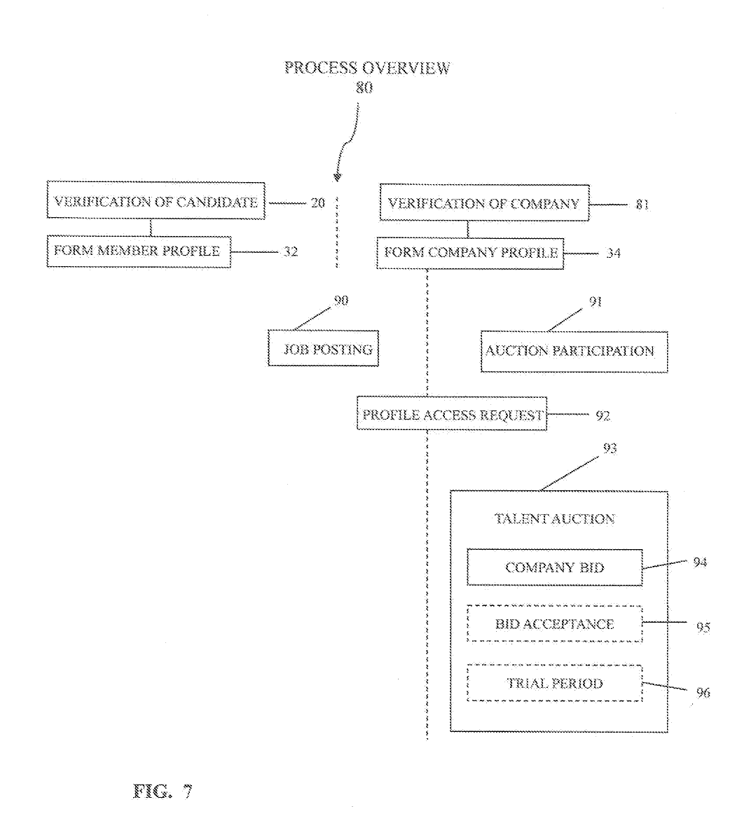

FIG. 7 is a process overview 80, illustrating steps for performing the method of the present invention. The process includes a verification step 20 for verification of a candidate, a company verification step 81, and if verified proceeds to step 82 wherein the company is allowed to bid. A step 32 indicates forming of a member profile, and a step 34 indicates forming of a company profile. A job posting step 90 is shown, and an auction participation step 91 is indicated. This is followed by a profile access request step 92, and a talent auction 93. The talent auction 93 includes a company bid 94, a bid acceptance 95, and a trial period 96. Furthermore, a company may review a member in relation to a job posting outside an auction as a result of step 92.

The following is a further detailed discussion of the invention.

### I. Verification

GotGuru verifies all member candidates using the following process:

Online Assessment->ID Verification->>Real World Skills Test->>Interview->Reference Check

A. Online Assessment

A simple assessment system grading logical reasoning, verbal reasoning, numeric reasoning and general communication skills.

B. Real Skills Test (Define Real World Problem)

An online test with realistic problems and questions. Test and each individual problem/question is graded across multiple dimensions including time to complete. Each score shows rank within the overall GotGuru membership. The scores and rankings will show on the member profile page.

B.1. Test Verification System

The biggest problem with online testing is the inability to verify who is taking the test. The GotGuru test verification system uses a combination of elements to verify that the person taking the test is the correct person. The system uses a combination of:

B.1.a) Periodic image snapshots for offline or interactive verification
B.1.b) Random prompting for identity verification via webcam. This requires the user to look directly into the webcam and can utilize facial recognition or manual review to verify user identity
B.1.c) Random third party account verification. By prompting the user to login to third-party verified accounts we can validate the identity of the user. In general; users will not want to share their PayPal, Facebook, LinkedIn login information, credit card account numbers, or other important personal information.
B.1.d) Random 2-Factor authentication. At random intervals, send a unique passphrase/image or other unique data to a test takers registered phone. Then request entry/selection of that unique data.

A future implementation may involve native software that would disable any non-approved network activity, enforce a single local keyboard input device, and/or detect/disable any remote desktop/terminal software running,

C. Interview

The interview is conducted with multiple interviewers. Each interviewer assigns a grade for each measured dimension. The grades are combined, if the deviation of grades is more than a defined percentage or number of standard deviations, then an external review of the interview is conducted. The grades per dimension are published as part of the candidate profile, and rankings within the member system displayed. In addition, a capture of the interview is online as part of the member's profile.

D. Reference Check

The system documents feedback from multiple references, utilizing LinkedIn© and other sources as necessary to get valid reference feedback. The feedback is then graded across multiple dimensions and consolidated so that multiple responses will provide a single grade for each dimension.

E. Company Verification

To prevent recruiters, straw men or other problematic access to the member and/or auction system, all participating companies will go through a verification process. Only approved will be able to bid in an auction or post jobs.

### II. Member System

The GotGuru member system allows for comprehensive user and company profiles. The profiles are the most complete in the industry.

The member profile includes:
Job History
Self-Assessment of Skills (Skill, Years Exp, Self-assessed skill level)
Real World Skills Test results and rankings.
Multi-Dimensional Interview assessment
Online Interview Video
Online Video CV/Intro
Online References/Recommendations

The Company Profile includes:
N-Level Company Hierarchy (Dept/Branch)
# employees at each level
Syr revenue/profit/budget range
Stage: Public Established, Public Startup, Private Established, Private Startup
Field of Business
Top Descriptors (rank top 3): Innovative, collaborative, strategic, stable, rewarding, Employee Growth, Positive, Driven, Challenging, Rewarding, etc.
Work environment: office, collaborative, modern, retro, and so on. It could include tele-commute options, work hours: 40-50, 50+, etc.
Position Profile includes:
Title
Responsibilities
Work hours
Work environment
Skills required
Skills utilized
Manager profile+Online Video
Promotion path

A. Anonymous Profile

A major advantage of the GotGuru system is the ability to maintain complete anonymity. All personally identifiable information is kept private by default. The member can control privacy by receiving requests from companies and accepting/denying those requests. This information includes (but is not limited to):

Name, email, phone #, IM and other contact points

### Previous Company Names

Year of college graduation

### Picture

### Interview Video

### CV Video

Reference/Recommendation identifiable information (Company, Name, etc.)

While some systems allow for limited anonymity, GotGuru (“GG”) allows the user complete control of who can access their profile.

B. Candidate Evaluation

GotGuru offers a service where the GotGuru process can be applied to candidates for a specific company opening. In this case, for a fee, the candidate is evaluated per the standard process and the results provided to the hiring company.

C. Employee Evaluation

GotGuru also offers an employee evaluation utilizing the GotGuru process. A company can pay a larger fee to get a complete GotGuru ranking/scoring for any employee.

D. Find Similar Functionality

If the company utilizes the employee evaluation, they can then search for members with similar scores/rankings, showing matches by percentage match.

### III. Talent Auction System

GotGuru is a full talent auction system allowing companies and verified candidates to be matched.

There are three potential auction formats: Ongoing Variable Auction, Multi-Acceptance Auction, and Fixed Date Auction The most feasible is the Fixed Date Auction. A Fixed Date Auction is an auction that is held on a specific date. (Auctions maybe for employee or contract positions) All auction formats include the following:

A. Payment Options

Upfront payment is a set fee determined at close of auction and is due within 30 days of auction closing. The fee is fully or partially refundable should the employment terminate during the guarantee period. If the auction is for a contract position, the fee is non-refundable after the trial period.

Payment plan: this allows payments to be spread out on a monthly basis for a predetermined period. The payment plan is terminated during that period if the employment is terminated. An example would be a payment of 1 of salary+bonus per month, for 24 months. if employment was terminated after 6¼ months, the employer would pay only 7%.

A minimum fee applies.

B. Talent Bid

A bid is a combination of salary, bonus, benefits, and other pertinent attributes (Examples: work environment, flexible hours, remote work options, onsite meals/soda, etc.). The bid is a binding offer.

C. Trial Period

The trial period is a 2-day period where the member and company contract at the bid-equivalent hourly rate. At the completion of the trial period, either party may cancel the contract. There will be a penalty for cancellation of a contract. This cancellation fee is substantial, but less than the full contract amount.

D. Bidder Participation

Any company with a legitimate job opening is allowed to participate in an auction. From startups offering no salary, just equity, to large corporations with private car service and fractional jet perks. Once the company has been verified, they are allowed to participate.

E. Previous Bidding History

Once a company is verified and pays their membership fee, they may see results from previous auctions. In addition, they have the ability to search previous auctions for talent similar to what they are looking for, by scores, rankings, skills, etc. They can then see what the recent market rates where for similar candidates.

F. Bidder Acceptance/Rejection

A member will be notified about a potential company bidder and must accept the bidder in order for the company to place a bid. A member may reject any potential bidder. Once a company's bid is accepted they will have full access to the member's public profile. The member will have full access to both the company and position profile.

G. Auction Transparency

All bids will be public during the auction period, but show limited bid content such as salary+bonus. Any company identifiable information will remain private to the bidder and member. To maintain company privacy, no company identifiable information will be displayed. at the same time as the bid information to the member. This prevents members from taking screenshots to show what companies are making what bids.

H. Auction Communication

During the auction all parties will be able to communicate using IM built-in to the system. This is preferably not done in VOIP unless a transcript can be captured, since there is a need to have such communications in writing.

I. Bid Acceptance/Winning

An auction is “won” when the member accepts the winning bid. A member does not have to accept any bid. A member can accept any bid at any time during the auction. Once a bid is accepted, the member and company are required to complete the trial period.

J. Bid Ran king/Acceptance/Rejection

During the auction the member may maintain a bid ranking by ranking the top 3 offers in preferred order. The member may also explicitly reject any bid, counteroffer a bid, or at any time accept a bid and thereby close the auction.

K. Auction Formats

K.1. Fixed Date Auction

The auction is held on a specific date and lasts for a set period of time. The auction may include one or more members, and one or more companies. Members and companies pre-register for the auction.

During the bidding process the member can rank the top 3 bids, reject bids, or counter offer any bid. The bidding company's information will be private to other bidders. However, the bid details will be public and the member will always be able to see full company details. A company can only one active bid for one member per open position (rejected bids are not considered active).

K.2. Ongoing Variable 3/7/10/14 Day Format Auction

In this auction format bidding for a member is available for a determined period of time. Since bids are binding, a company may only bid on one member at a time per job opening. Start date is determined by the member.

K.3. Multi-Acceptance Auction

In this auction the company is bidding on the right to interview the member. The offer is binding as a minimum offer should the company employ the candidate. The company and member will rank all bids at the end of the auction period. A computer will create a combined score of company ranking+member ranking to find the best matches. The top 3-5 matches will coordinate interviews. The interviews will take place within a defined period (interview period). Any hiring of the Guru member by bidding company Within a period after the auction (Extended period) will constitute employment through GotGuru and incur the requisite fees. Failure to interview will incur a penalty and potential membership revocation.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A method for providing online assessment of employment candidates which includes an online skills test with a test verification system, comprising the steps of:
providing a computer system and storage,
conducting an interview and storing the results in said storage,
performing a reference check and storing the results in said storage,
providing a member system and storing the results in said storage, and
performing a talent auction using said computer system, including using the results of said interview, said reference check, and said member system.

2. The method of claim 1, further comprising the step of using said computer system for conducting verification of the candidate by use of identification checks.

3. The method of claim 2, wherein a plurality of identification steps are performed at intervals.

4. The method of claim 2, wherein a plurality of identification steps are performed at random times.

5. The method of claim 2, wherein a plurality of identification steps are performed at intervals and include a minimum of two of: online computer query, online table/mobile device query, cell phone query, smartphone query, audio query, and video monitoring.

6. An online auction system using a computer system and communication system for conducting a talent auction, comprising the steps of:
providing a computer system and communication system;
conducting a talent bid by participating companies;
providing bidder participation;
providing auction communication; and
providing a step for bid acceptance and for bid rejection.

7. The method of claim 6, further comprising the step of providing an auction format which is a fixed date auction.

8. The method of claim 6, further comprising the step of providing an auction format which is an ongoing variable day format auction.

9. The method of claim 6, further comprising the step of providing an auction format which is a multi-acceptance auction.

10. The method of claim 6, further comprising the step of providing payment options, which can include a fee due at close of auction and a guarantee period.

11. The method of claim 6, further comprising the step of providing a step of auction transparency.

12. The method of claim 6, further comprising the step of providing a step of a trial period.

13. A method for providing online assessment of employment candidates which includes an online skills test with a test verification system wherein there is a candidate location separate from a computer system which administers testing, comprising the steps of:
providing a computer system and storage;
providing a candidate location;
providing a step of ID verification; and
providing a step of online testing verification.

14. The method of claim 13, wherein said step of online testing verification includes queries to the candidate's location at random times.

15. The method of claim 13, wherein said step of online testing verification includes queries to the candidate's location using a phone.

16. The method of claim 13, wherein said step of online testing verification includes queries to any of a candidate's mobile device, cell phone, tablet computer, and computer.

17. The method of claim 13, wherein said step of online testing verification includes queries to the candidate's location using texting to a candidate's mobile device.
